(19) United States
(12) Patent Application Publication
(10) Pub. No.: US 2004/0186339 A1
(43) Pub. Date: Sep. 23, 2004

(54) System and method of capturing and destroying organic hazardous agents released within an enclosed space

(76) Inventor: Terry R. Galloway, Berkeley, CA (US)

Correspondence Address: COUDERT BROTHERS, 3000 El Camino Real Building 2, Palo Alto, CA, 94306, US

(21) Appl. No.: 10/783,900

(22) Filed: Feb. 19, 2004

Related U.S. Application Data
(60) Provisional application No. 60/456,689, filed on Mar. 21, 2003.

(51) Int. Cl. A62D 3/00

(52) U.S. Cl. 588/213

(57) ABSTRACT

The system includes a blower for circulating air during a normal in-service operation to a building having a number of enclosed spaces, at least one filter containing a bed of, for example, about 100 tons of granulated activated carbon for capturing bio-agents that may be present in the air, and a steam/carbon dioxide reformer for destroying the bio-agents captured on the bed in the presence of steam and syn-gas being circulated over the bed during the reactivation operation. The method includes passing the air through the filter bed, circulating the filtered air to the enclosed spaces during the in-service operation, detecting and warning building occupants with a biosensor within the enclosed spaces of the possible any bio-agent release, adsorbing on the bed any bio-agents, sealing off air circulation, passing a steam and syn-gas mixture through the bed if a bio-agent is detected; and circulating steam from the bed to a steam/carbon dioxide reformer to destroy the bio-agents on the bed.

### CROSS REFERENCE TO RELATED APPLICATION

This application claims the benefit of U.S. provisional application Serial No. 60/456,689, filed Mar. 21, 2003.

### FIELD OF INVENTION

The present invention relates to adsorbing onto filter beds organic hazardous agents (bio-agents) released within an enclosed space or into its air intake. More particularly, the present invention relates to capturing bio-agents that may be released particularly in buildings of critical importance, destroying the captured bio-agents, and reusing the filter beds.

### BACKGROUND OF THE INVENTION

Subsequent to the Sep. 11, 2001 disaster in the United States, the U.S. Department of Homeland Security was established to place various governmental agencies under one umbrella to more efficiently guard against future attacks using chemical weapons agents (CWA), e.g., biological weapons, nerve gas, and other organic hazardous chemicals. Examples of bio-agents include weapon-grade anthrax, botulinum toxin, aflatoxin, and nerve gas agents such as VX, sarin, and ricin. Weapon-grade bio-agents are developed specifically for release into buildings of critical importance. The release of a bio-agent into critical facilities or the air intakes of such facilities would result in widespread death and disruption of governmental and commercial activities. Currently no facilities in the world are equipped to guard against such releases.

It is apparent that at this time in history there is a need for a system that will protect the occupants of buildings and other facilities having a critical place in the government and commerce from the release of bio-agents by accident or by terrorist attack.

### SUMMARY OF THE INVENTION

To fulfill this need, the present invention provides a system for capturing and destroying organic hazardous agents referred to herein as bio-agents.

The system comprises:

a) circulating means for circulating a gas;

b) at least one filter containing a bed of material for capturing bio-agents and placed so that air is passed though the bed prior to being passed to an enclosed space; and

c) destruction means for destroying the bio-agents captured on the bed.

Air is used as the gas during an in-service operation. During a reactivation operation, preferably the destruction means is steam/carbon dioxide reforming where steam and syn-gas is the gas that is circulated.

The method of the present invention comprises the steps of passing the air through the filter bed, circulating the filtered air to the enclosed spaces of a building during the in-service operation, detecting and warning building occupants with a biosensor within the enclosed spaces of a bio-agent release, adsorbing on the filter bed any bio-agents, sealing off air circulation from at least the enclosed space in which a bio-agent release is detected from each of the other enclosed spaces, passing steam and syn-gas through the filter bed if a bio-agent is detected, and circulating steam and syn-gas from the filter bed to a steam/carbon dioxide reformer to destroy the bio-agents adsorbed on the filter bed during the reactivation operation.

### BRIEF DESCRIPTION OF THE DRAWINGS

Further features and advantages will become apparent from the following and more particular description of the preferred embodiment of the invention, as illustrated in the accompanying drawings in which:

FIG. 1 is a schematic diagram of one embodiment of the present invention;

FIG. 2 is a schematic diagram of the embodiment shown in FIG. 1 combined with a typical critical facility; and

FIG. 3 is a schematic diagram of a room or other enclosed space of a typical critical facility that is protected by the system of the present invention.

### DETAILED DESCRIPTION OF THE BEST MODE OF THE INVENTION

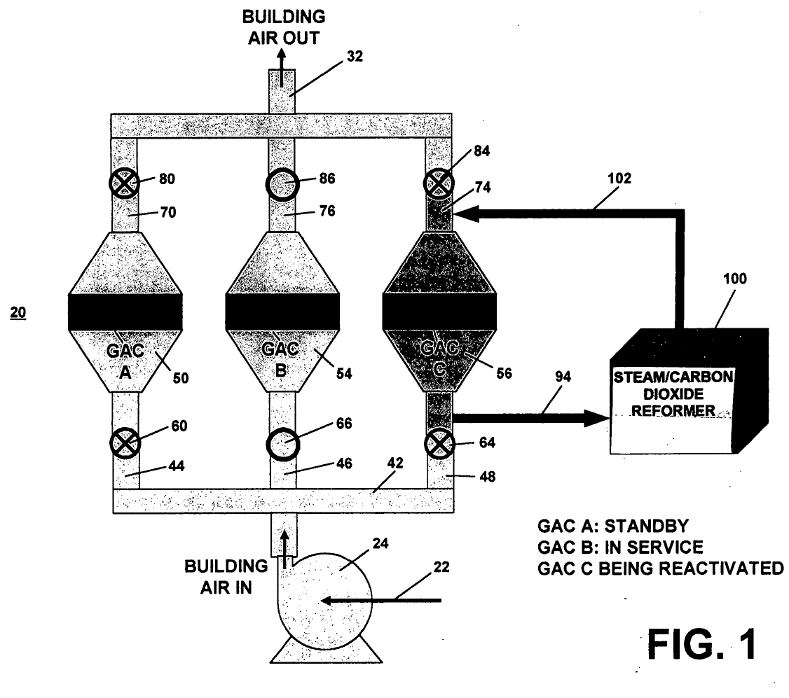

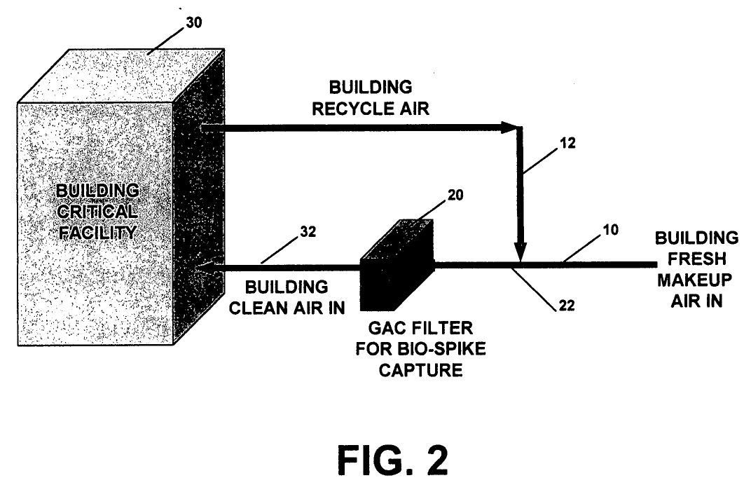

Referring now to FIGS. 1-3, schematic diagrams are presented illustrating the system of the present invention. Fresh make-up air passes through line 10, is combined with recycled air in line 12 and the combined air stream enters the bio-agent capture and destruction system 20 through line 22 and blower 24 or other suitable circulation means for circulating large volumes of gas. Filtered air leaves system 20 and enters the air circulation system of critical facility 30 or other building through line 32. The filter system shown in FIG. 1 comprises blower 24 that passes the combined air in line 22 into plenum chamber 42 to supply air to entry ducts 44, 46 and 48 that respectively pass the air through filters 50, 54, and 56. Entry valves 60 and 64 respectively in ducts 44 and 48 are closed and entry valve 66 in duct 46 is open. The filtered air exits the respective in-service filter though one of the exit ducts 70, 74 and 76 having exit values 80, 84 and 86. Exit valves 80 and 84 in exit ducts 70 and 74 are shown in the closed position and exit valve 86 in duct 76 is in the open position. Filter 50 containing bed A of a suitable filter medium, for example, granular activated carbon (GAC), is shown on standby status. Filter 54 containing bed B of GAC is shown in the in-service position. Filter 56 containing bed C of GAC is shown with air inlet valve 64 and air exit valve 86 closed and bed C being reactivated by the destruction of bio-agents. This is done by introducing a steam and syn-gas mixture in line 102 and circulating the steam and syn-gas mixture through conduit 94 to means for destroying bio-agents and reactivating the GAC, e.g., steam/carbon dioxide reformer 100, and returning the stream to filter 56 via effluent conduit 102.

The means for destroying the bio-agents suitable for use as the steam/carbon dioxide reformer 100 is shown and described in detail in a paper presented to the 1993 AIChE Summer National Meeting by Dr. T. R. Galloway, entitled “New Methods For The On-Site Reactivation of Granular And Powdered Activated Carbon” during Aug. 16-20, 1993, in the U.S. Patent Publication No. 20030022035-A1, published Jan. 30, 2003 entitled “Process And System For Converting Carbonaceous Feedstocks Into Energy Without Greenhouse Gas Emissions,” and in a U.S. patent to T. R. Galloway, “Process for Reactivating Particulate Adsorbent”, filed Nov. 18, 1992, Ser. No. 07/978,265, U.S. Pat. No. 5,292,695. Additional details of a typical steam reformer is shown and described in U.S. Pat. No. 4,874,587. The pertinent portions of the paper, the publication and each of these patents are incorporated herein by reference.

During the initial phase of the destruction of bio-agents, a gas effluent is sent from steam/carbon dioxide reformer 100 through conduit 102 to, for example, GAC filter 56 containing the contaminated bed C to remove all the air in the filter bed C system. Steam/carbon dioxide reformer 100 can be either a gasification unit such as a kiln as described in detail in U.S. Patent Publication No. 20030022035-A1 or a heated reactor that operates at temperatures of at least 1800° F. and a source of superheated steam for introducing steam to the gas in conduit 94 from filter 56. In the case of a heated reactor, a first heat exchanger removes heat from the reactor effluent, a turbine passes the effluent through a second heat exchanger, and an adsorber bed removes trace bio-agents before the gas effluent is passed through the second heat exchanger and effluent conduit 102. The steam is added to conduit 94 in an amount that is required to react with substantially all bio-agents and other organic compounds in the circulating gas stream.

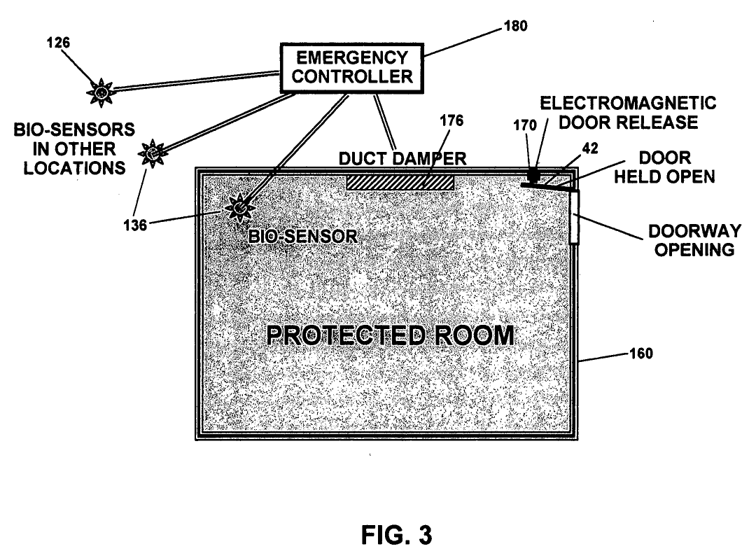

FIGS. 1-3 represent a simplified bio-agent capture and bio-agent destruction system for a building having a large number of protected rooms 160, one of which is shown in FIG. 3. A typical design of air circulation and ventilation systems for buildings is shown in the American Society of Heating, Refrigerating and Air-Conditioning Engineers (ASHRAE) Handbook; the description of which is incorporated herein by reference. Each of the protected rooms 160 can be closed and completely sealed off from each other. Protected room 160 has fire door 162 held open by standard fire-protection electromagnet 170 triggered by fire or other emergency. Room 160 also has HVAC (Heating, Ventilation, and Air Conditioning) vent dampers 176. Both the door and the vent dampers are closed by emergency controller 180, which is triggered by any one of biosensors 136 within this room or from biosensors 126 in other locations. Upon a bio-agent release that is detected by one or more of the biosensors, the one or more protected rooms 160 are sealed off (shuttered in place). Biosensors are presently available for use in military applications for sensing bio-agents and are used to alert for military personnel to don gas masks and other protective equipment. For a discussion of the role these type of sensors will play in homeland security, see magazine articles by Amanda Yarnell, “Role of Research in Homeland Security”, Chemical & Engineering News (Chem. E. News), Sep. 9, 2002 and Lois R. Ember, “Science, Technology and Homeland Security, Chem. E. News, Aug. 12, 2002, pp. 26-28.

Biosensors 126 and 136 are connected into the NFPA standard fire protection systems in accordance with NFPA (National Fire Protection Association) Rule 80 (Standard for Fire Doors and Fire Windows) and rule 90A (Standard for the Installation of Air-Conditioning and Ventilating Systems) in buildings where the fire doors are automatically closed. Fire doors 162 each have electromagnet door release 170 to hold them open in normal, non-emergency situation. In the event of an emergency, such as a fire alarm, smoke, and the sensing of a bio-agent, all fire doors 162 are closed automatically. All new buildings that meet fire code have such fire door systems in place and installing biosensors to activate the fire doors is within the capabilities of one skilled in the art.

The biosensors are placed throughout the building at major air handling units. These biosensors require about 20 minutes to detect and confirm to a high level of accuracy (>99% reliability against false positives). GAC filters 50, 54 and 56 form an integral part of the building air circulating system and operate 24 hours, 7 days per week. As stated above, upon the introduction of a bio-agent into air inlet line 10 or anywhere within the facility, one of these biosensors will sound an alarm. After the bio-agent spike, i.e., the bio-agents are adsorbed within the interstices or pores of the carbon bed, the GAC filter 24 that is in service will have processed about 20 million ft.³ of air before there is confirmation that a real bio-agent spike has been detected. At this point, the GAC filter 24 contains the spike, and the section of the building, in which the biosensor confirms a bio-agent release and sounds an alarm, is sealed off from the rest of the building as discussed above. Therefore, each filter must contain a sufficient amount of GAC bed to prevent a breakthrough of the bio-agent spike from the bed into any section of the building during the time required by the biosensor to detect and confirm a release of bio-agents and to sound the alarm. Calculations are set forth below for the amount of GAC required for a typical critical facility that would use the system of the present invention.

The building occupants would immediately leave the contaminated section of the building and are either appropriately treated with antidotes for the bio-agent if it is known or quarantined while an analysis is made to determine the agent. All operations thereafter would require the use of remote operational controls or manual work through an air suit, i.e., Scot Air packs or biohazard suits.

The remaining sections of the building would continue to have its air processed through a GAC bed, since there will be long resident time tails resulting from this spike and the GAC still will have safety capacity remaining well before the bed becomes saturated and at capacity. For added safety, there could well be two of these beds in series (not shown), so that the second bed is a polishing bed to assure added removal efficiency, redundancy and safety. After some period of time, i.e., many hours, when the bio-agent levels decline to below safe levels, an alternate GAC bed can be switched to the in-service position to continue the building safety and the contaminated GAC bed is then removed from service and steam/carbon dioxide re formed as discussed above to destroy all of the bio-agent.

The release of about 5 tons of a bio-agent into a critical facility is considered a maximum credible quantity. Using this release as a basis for calculations, it is proposed such organics will be adsorbed on a GAC bed that is designed to be substantially equivalent to a well designed HEPA filter; see U.S. Pat. No. 6,428,610 for details of HEPA filters, which patent is incorporated herein by reference. The upper saturation level of each of the GAC beds is set at 10% to be safe, even though a typical GAC bed has a capacity around 15%. Because each of the GAC beds is only partially exhausted, the amount of GAC having a density of 40 lbs/ft.³ for a release of about 5 tons of bio-agent is about 100 tons.

It is estimated that the critical facility has approximately a million square feet of space with 10 feet of space between floors, or an estimated 10 million ft.³ of air involved that could become contaminated. In a typical building, there is about 5 air changes per hour. Therefore to be safe, the system of the present invention for this example must process 10 million ft.³ of air in 10 minutes or 1,000,000 scfm. The air velocity within each of the GAC beds is under 10 ft./sec or 600 ft./min. To meet these criteria, a 1600 ft.² GAC bed cross section or 40 ft.×40 ft. of bed is required. The bed depth of GAC to provide the above capacity is:

Depth=100 tons×2000 lbs./ton/(40 lbs/ft.³×1600 ft.2)=approximately 3 feet

Using a typical HEPA filter with a depth of 12 inches and 2 ft.×2 ft. in cross section has a 1 inch w.c. (water column) pressure drop at 1000 scfm, the 3 foot bed of GAC has a pressure drop of 6.4 in. w.c. at 1,000,000 scfm. This higher pressure head can be provided by a higher efficiency centrifugal blower operating at high rpm. The GAC filter for this example requires a stack of 100 blocks of GAC measuring 2 ft.×2 ft.×3 ft. in size and placed and sealed into a heavy duty rack within the air circulation system as shown in FIG. 1. Each rack of GAC would weigh about 240 tons, with each individual GAC block weighing 480 lbs. The filters are placed in a high bay space with crane capability to install, remove and replace each of individual blocks in this rack.

There are many other variations of the system of the present invention using other filter media other than GAC to capture certain bio-agents, e.g., molecular sieves, zeolites, silica gel, natural adsorbent minerals, and the like. Various modifications of the invention in addition to those shown and described will become apparent to those skilled in the art from the foregoing description and accompanying drawings. Such modifications are intended to fall within the scope of the appended claims.

What is claimed is:

1. A system for the capture and destruction of organic hazardous agents (bio-agents) comprising:
a) circulating means for circulating a gas;
b) at least one filter containing a bed of material for capturing bio-agents and placed so that air is passed though the bed prior to being passed to an enclosed space; and
c) destruction means for destroying the bio-agents captured on the bed.

2. The system of claim 1, wherein the destruction means is a steam/carbon dioxide reformer.

3. The system of claim 2, further comprising another filter containing another bed of the material for use while a first bed of a first filter is undergoing steam/carbon dioxide reforming.

4. The system of claim 1, wherein the material for capturing bio-agents is granular activated carbon (GAC).

5. A system for the capture and destruction of bio-agents comprising:
a) a building having a plurality of enclosed spaces;
b) circulating means for circulating a gas;
c) at least one filter containing at least one bed of granular activated carbon (GAC) and placed so that air is circulated though the GAC bed prior to being passed to each of the enclosed spaces;
d) a biosensor within each of the enclosed spaces for detecting and warning any building occupants of a release of bio-agents;
f) means for sealing off each of the enclosed spaces after sufficient evacuation time; and
g) a steam/carbon dioxide reformer for reactivating the GAC bed to destroy the bio-agents adsorbed on the GAC bed.

6. The system of claim 5, further comprising a second filter containing a second GAC bed for use while a first GAC bed of a first filter is undergoing steam/carbon dioxide reforming.

7. The system of claim 5, further comprising a second filter containing a second GAC bed placed in series with a first filter containing a first GAC bed to assure capture of substantially all of the bio-agents.

8. The system of claim 7, further comprising a third filter containing a third GAC bed for use while the first GAC bed is undergoing steam/carbon dioxide reforming.

9. The system of claim 5, further comprising a plurality of rooms having means for sealing off each room from each of the other rooms.

10. The system of claim 9, wherein a fire door is used to seal off each room from each of the other rooms.

11. The system of claim 10, further comprising an emergency controller means operably connected to said biosensor and said fire door to cause the fire door to close upon the sensing of a bio-agent within the room.

12. The system of claim 5, wherein said gas is air during an in-service operation.

13. The system of claim 5, wherein said gas is steam or a steam and syn-gas mixture during a reactivation operation.

14. The system of claim 13, wherein the steam or steam and syn-gas mixture is superheated.

15. The system of claim 5, wherein said circulation means is a blower.

16. The system of claim 5, wherein said steam/carbon dioxide reforming takes place at temperatures of at least 1800° F.

17. The system of claim 5, wherein said filter contains a sufficient amount of GAC to prevent a breakthrough of a bio-agent spike from the GAC bed into any enclosed space during the time required by the biosensor to detect and confirm a release of the bio-agent and to warn the building occupants.

18. The system of claim 17, wherein said filter contains about 100 tons of GAC.

19. The method of capturing and destroying organic hazardous agents (bio-agents) comprising:
a) passing air through at least one filter containing a bed of material for capturing bio-agents;
b) circulating the filtered air to a building having a plurality of enclosed spaces during an in-service operation;
c) detecting a release of bio-agents with a biosensor located within the enclosed spaces;
d) adsorbing on a filter bed bio-agents present in the air prior to the air being passed to the enclosed space;
e) sealing off the circulation of air from the enclosed space in which a bio-agent has been detected from the other enclosed spaces after a sufficient evacuation time has elapsed;
f) passing steam and syn-gas through the at least one filter if the biosensor detects a release of bio-agents; and
g) circulating the steam and syn-gas mixture from the at least on filter to a steam/carbon dioxide reformer to destroy any of the bio-agents that have been adsorbed on a filter bed after a release of a bio-agent has been detected during a reactivation operation.

20. The method of claim 19, wherein the material for capturing bio-agents is granular activated carbon (GAC).

21. The method of claim 19, further comprising passing the air through a second filter containing a second bed for use while the bed of a first filter is undergoing the reactivation operation.

22. The method of claim 19, further comprising passing the air through a second filter containing a second bed placed in series with a first filter containing a first bed to assure capture of substantially all of the bio-agents.

23. The method of claim 19, further comprising passing the air through a third filter containing a third bed for use while the first bed is undergoing steam/carbon dioxide re forming.

24. The method of claim 19, wherein the steam and syn-gas mixture is superheated.

25. The method of claim 19, wherein said steam/carbon dioxide reforming takes place at temperatures of at least 1800° F.

26. The method of claim 20, wherein the biosensor warns occupants of the building of any release of bio-agents.

27. The method of claim 26, wherein said filter contains a sufficient amount of GAC to prevent a breakthrough of a bio-agent spike from the GAC bed into any enclosed space during the time required by the biosensor to detect and confirm a release of bio-agents and to warn the building occupants.

28. The method of claim 27, wherein said filter contains about 100 tons of GAC.
